(19) United States
(12) Patent Application Publication
(10) Pub. No.: US 2014/0203055 A1
(43) Pub. Date: Jul. 24, 2014

(54) Reminder Bag Carrier

(71) Applicant: Ezequiel Salinas, Canoga Park, CA (US)

(72) Inventor: Ezequiel Salinas, Canoga Park, CA (US)

(73) Assignee: Ezequiel Salinas, Canoga Park, CA (US)

(21) Appl. No.: 13/747,467

(22) Filed: Jan. 22, 2013

(51) Int. Cl. B60R 9/055

(52) U.S. Cl. CPC B60R 9/055
USPC 224/486

(57) ABSTRACT

This is a reminder bag carrier which contains four small container bags. Each of these small container bags holds a larger bag intended to be used for shopping. The zippered reminder bag carrier may be conveniently attached to a car door as a reminder for the user to take their shopping bags into the store, as may be required by law. Alternatively, the user may carry the zippered bag by attaching it to his or her person or purse by means of the Velcro handle strap. This is intended to remind the user to take needed shopping bags into a store, thus negating the necessity of buying paper bags or using plastic bags which are presently freely issued. (Anticipated laws, beginning January, 2013, will ban the use of plastic bags and necessitate a charge of 10 cents for each paper bag. Eventually paper bags will also be banned.) This is a reminder bag carrier may also contain devices or items of necessity to the artist, journalist, musician or any person who needs items of personal importance.

### CROSS-REFERENCE TO RELATED APPLICATIONS

None.

### FEDERALLY SPONSORED RESEARCH

None.

### SEQUENCE LISTING

None.

### BACKGROUND

This relates to shopping bags which customers may bring to any store. The zippered reminder bag carrier to be attached, with Velcro, to a consumer's car door makes it easier for them to remember to bring these shopping bags into a shopping venue, and so avoid conflict due to a new law that will to go into effect in Los Angeles, Calif. in January, 2013. The banning of the use of plastic shopping bags for protection of the environment, for example, began in the city of Calabasas, Calif., on Jul. 11, 2011. Many customers have expressed disbelief and some angrily left the store leaving behind shopping carts full of groceries, refusing to pay ten cents to purchase a paper bag. Being in the retail grocery industry for the last twenty years and currently a manager, I have witnessed this behavior in the city of Calabasas, Calif., at Ralphs supermarket. It is the intention of this applicant, as the creator of the proposed zippered shopping bag carrier, to make the transition as easy and efficient as possible for customers who will be required to bring their own shopping bags or to purchase store-bought paper shopping bags. There is a distinct possibility that customers in the City of Los Angeles, will be even more aggressive than those who have been forced to purchase paper shopping bags in relatively more affluent and peaceful locations. The purpose of this invention is to have a small bag made of suitable material such as quilted fabric, leather, suede, canvas, cotton, etc. The small bag carrier can be closed by zipper, which may be attached with Velcro or magnet, to the car door of the customer. This zippered bag has a handle separable in two parts, closable with Velcro, designed to be attached to the customer's belt or purse. The outer bag will contain several nested smaller synthetic bags which, in turn, may be opened up to become larger shopping bags.

U.S. Patents

| Patent Number | Kind Code | Issue Date | Patentee |
|---|---|---|---|
| 6,213,267 | B1 | 2001 Apr. 10 | Miller |
| 6,971,424 | B1 | 2005 Dec. 06 | Angevine |
| 7,963,427 | B2 | 2011 Jun. 21 | Calkin |
| 7,621,305 | B2 | 2009 Nov. 24 | Cho |
| 6,619,447 | B1 | 2003 Sep. 16 | Garcia, III, et al. |

U.S. Pat. No. 6,971,424 B1 is a handbag comprising of a frame and an insert. The insert is connected to the frame by any suitable means such as Velcro, magnetic strip or any combination of fasteners. The insert bag may be separated from the frame. Though inventor Elizabeth Angervine's interchangeable handbag may use some similar components such as Velcro and zipper fasteners, its purpose is entirely different and it is clearly not intended for use as a shopping bag.

U.S. Pat. No. 7,963,427 B2 is a strap attachment system for supporting articles such as backpacks, luggage, bags, and jackets. Inventor Carston R. Calkin's strap attachment system, in itself is an excellent idea and does not employ snaps, buttons, hooks or Velcro. It is not intended to be used to carry small synthetic container bags that open up to become large shopping bags.

U.S. Pat. No. 6,213,267 B1 is a portable luggage case with a detachable tote bag portion. Inventor Jacqueline N. Miller has created a tote bag, which may be attached to a suitcase by means of a zipper. It may be detached and used separately for carrying such items as computers. The detachable tote bag of Miller's invention is not intended to be attached to a car door by means of Velcro, further; it does not release synthetic shopping bags when unzipped.

U.S. Pat. No. 7,621,305 B2 is a foldable grocery bag organizer. Inventor Bryan H. Cho has created a device for holding shopping bags upright in the trunk of an automobile to prevent spillage. It employs Velcro on its base to prevent slipping on a carpeted surface. Cho's invention is used after shopping. The quilted zipper bag proposed in the present patent application is intended for use before and during shopping, although both may be stored in an automobile.

U.S. Pat. No. 6,619,447 B1 is a primary utility bag from which a smaller bag may be detached. The smaller bag is attached to and releases from the larger bag utilizing a system of separate buckles. The primary bag and the smaller bag both employ zipper fasteners but do not employ Velcro. The primary utility bag is intended for carrying large items or sporting articles, while the detachable smaller bag is intended merely for carrying of smaller items. It is not created to serve as a reminder to carry shopping bags into the store.

In conclusion, insofar as I am aware, no such Velcro or magnetic-attachable-to-car-door, reminder bag carrier (containing several nested smaller synthetic bags which, in turn, may be opened up to become larger shopping bags: also containing items ready for artists, journalist, musicians or any one who needs personal or emergency items) has been yet developed.

### SUMMARY

The proposed reminder bag carrier, designed to be attached to a car door with Velcro or magnet, is made of any suitable material such as quilted fabric, leather, suede, canvas, cotton, etc. It currently measures 7″×4″×3″. It is fastened by a zipper and contains four folded synthetic shopping bags each measuring 4″×4″. These, in turn, can be expanded to 18″×13″×7″ though sizes may vary. The handle of the zippered bag is made of cotton and closable with Velcro.

Accordingly, several advantages are present, which could help the environment by providing a replacement for free plastic bags (19 billion plastic bags used annually in Calif.) and obviating the necessity of purchasing paper shopping bags in Los Angeles Calif. (14,000,000 trees cut down annually in the US to make paper bags). Further, these bags are compact, inexpensive and easy to carry. The Velcro attachment makes it handy for customers to carry them in their cars or attach to their belts or purses. The zippered reminder bag carrier may also be used by artists to carry such necessities as brushes, pencils, tubes of paint and small pads of paper; by journalists who might carry hand-held recording devices, books and pens and by musicians who might carry portable audio and video recording devices. Still further advantages such as carrying wallets, flashlights, spare keys, cell phones and first aid kits will become apparent from a study of the following description and the accompanying drawings.

### DRAWINGS

FIG. 1 is a perspective side view of the unzipped, quilted bag (or fabric of choice) bag showing closed handle and open zipper.

FIG. 2 is a perspective end view of unzipped, quilted bag (or fabric of choice) bag showing open Velcro handle.

FIG. 3 is a bird's eye view of the quilted, (or fabric of choice) bag unzipped, showing four synthetic container bags inside. The Velcro handle of the reminder bag carrier is closed.

FIG. 4 is a lateral view of one of four synthetic container bags. This bag is closed by a pull cord and a plastic fastener. (Inside this smaller bag is contained a larger shopping bag.)

FIG. 5 is a lateral view of one of the four synthetic container bags. The bag is opened by releasing the plastic fastener which, in turn, frees the pull cord. (Inside this smaller bag is contained a large shopping bag.)

FIG. 6 is a front view which shows the smaller synthetic container bag to which is attached the larger shopping bag fully opened and ready for use.

FIG. 7 is a bottom view of the quilted (or fabric of choice) bag showing its Velcro Or magnetic patch (The Velcro handle is closed.)

FIG. 8 shows a view of the Velcro or metal/steel patch sticker to be attached to car door. The Velcro patch on the quilted (or fabric of choice) bag will then be attached to the Velcro or metal/steel patch on the car door.

FIG. 9 is a lateral view of the car door showing possible placement of the reminder bag carrier.

FIG. 10 is a schematic drawing showing the relative sizes of the quilted (or fabric of choice) bag, the container bag and the large shopping bag.

### DETAILED DESCRIPTION

FIG. 1 is a perspective view showing the lateral side of the quilted (or fabric of choice) bag 1 constructed in accordance with one embodiment. The zipper 2 of the quilted (or fabric of choice) bag is seen open. At the far right end of this quilted bag is the handle 3 and 4 in two parts; 3 has a Velcro patch sewn on the end of the handle's inside and 4 has a Velcro patch sewn on the end of the handle's outside. There are four small synthetic bags 5 each of which is closed by a pull cord. These four synthetic bags 5 are placed inside the zippered reminder bag carrier.

FIG. 2 is the perspective end view showing the Velcro handle in two parts 3, 4, unclasped. The Velcro patch 3 is sewn on the end interior of the handle 11. The Velcro patch 4 is sewn to the exterior of the handle 12. The quilted bag (or fabric of choice) is unzipped 2 and all four synthetic container bags 5 can be seen nested inside.

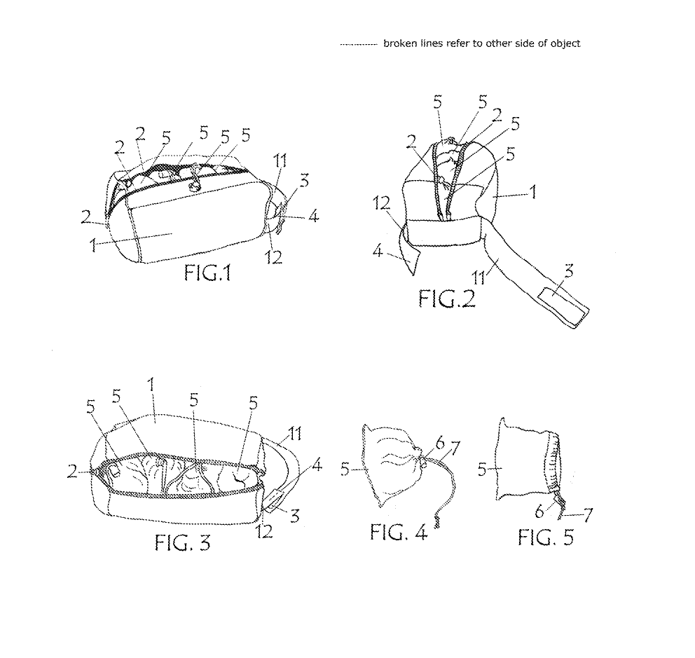

FIG. 3 is a bird's eye view of the entire quilted (or fabric of choice) bag from end 2 to end 3, 4, shown in the closed position. The longer handle 11 has Velcro on it's interior 3 fastened on to the smaller handle 12 which has Velcro on its exterior 4. Both patches 3 and 4 are joined by use of Velcro.

FIG. 4 is a lateral view of one of the four synthetic container bags 5. It shows a plastic fastener 6 which locks in the pull cord 7 in order to keep the small bag closed.

FIG. 5 is a lateral view of one of four synthetic container bags 5. This bag 5 is fully opened because the tension from the pull cord 7 has been released by allowing it to pass through the plastic fastener 6.

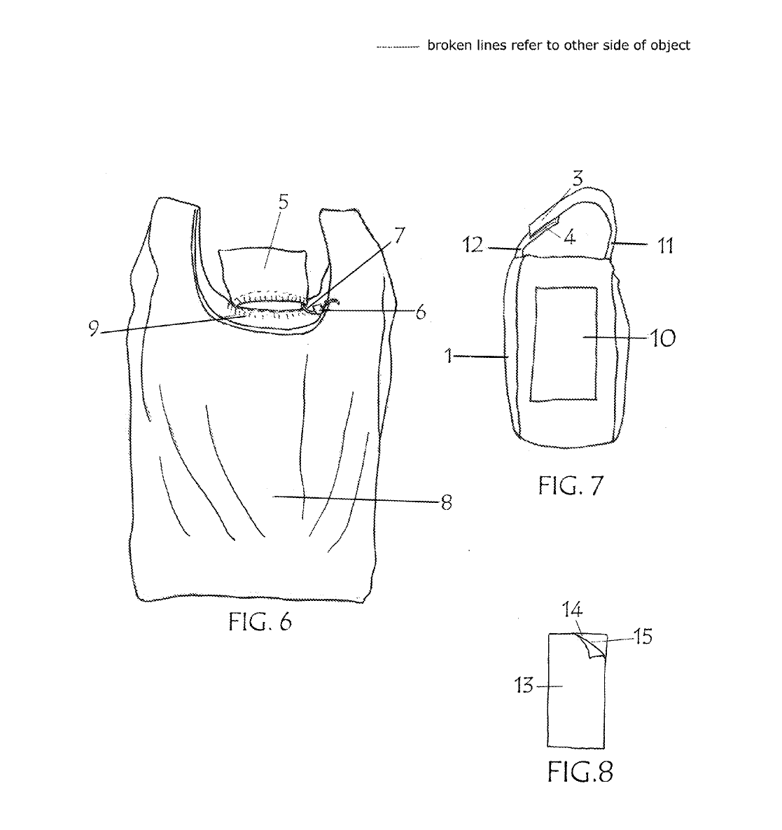

FIG. 6 is the front view of one of four synthetic shopping bags 8 fully opened which has been released from its container bag 5. It remains attached 9 to the container bag 5.

FIG. 7 is the bottom view of the quilted (or fabric of choice) bag 1. A large Velcro or magnet patch 10 is sewn on to the bottom of that bag. The handle in two parts 11, 12, is closed by means of attaching the Velcro patches 3, 4.

FIG. 8 is a plastic covering 13 which is removed and discarded. This reveals a Velcro or metal/steel sticker 14, which is affixed to the car door. The quilted (or fabric of choice) bag is then affixed to the car door by attaching its Velcro or magnet base 10 to the velcro patch 15 on the car door 16.

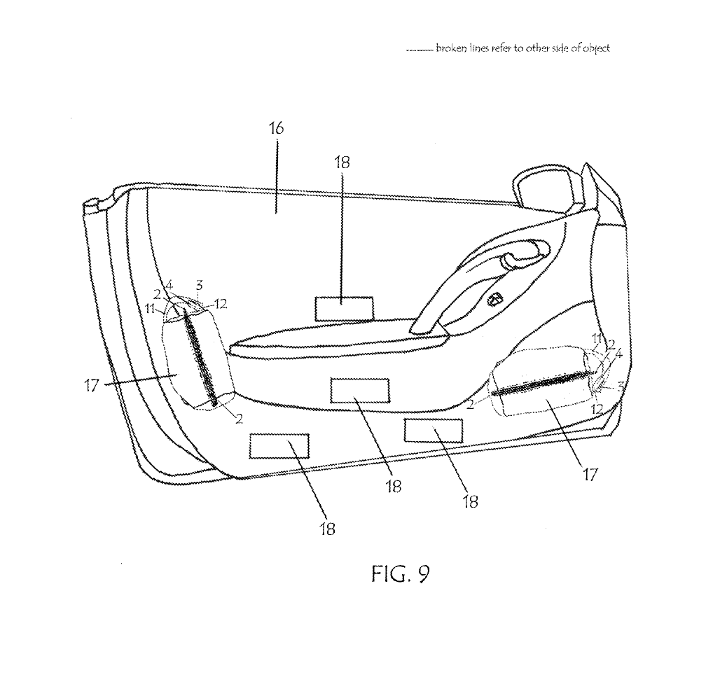

FIG. 9 shows a lateral view of a car door 16 indicating possible positions 18 for placement of the quilted zippered bag 17.

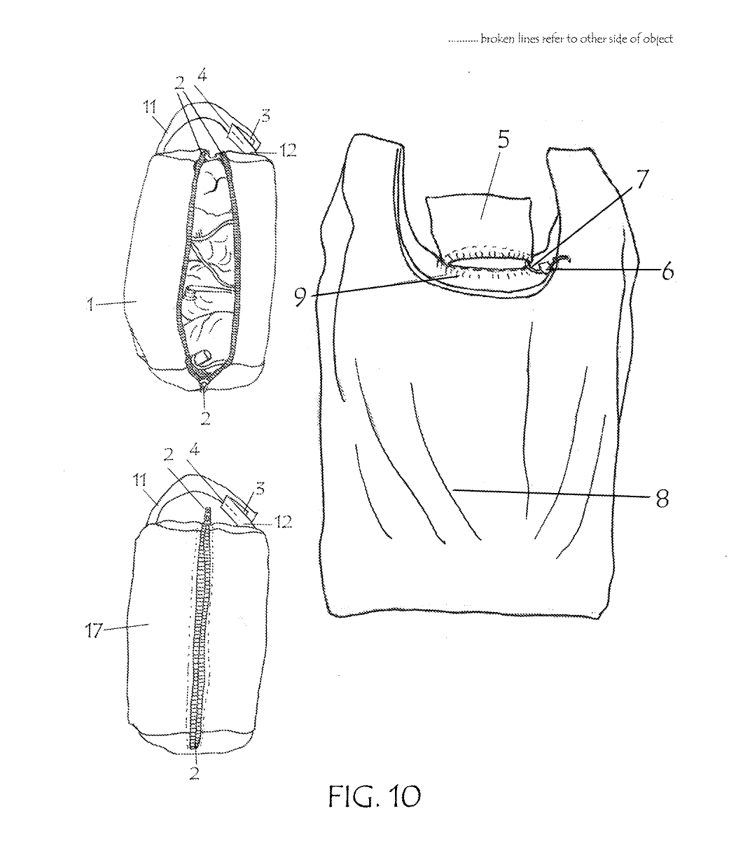

FIG. 10 is a schematic drawing showing relative sizes of the zippered reminder bag carrier 17 the synthetic container bag 5 and the large shopping bag 8.

### REFERENCE NUMERALS

1 outer quilted (or fabric of choice) bag
2 zipper
3 longer handle piece with Velcro patch or on inner face
4 shorter handle piece with Velcro patch on outer face
5 synthetic container bag
6 plastic fastener
7 pull cord
8 large synthetic bag fully opened
9 synthetic container bag sewn to large synthetic shopping bag
Velcro or magnet patch attached to bottom of quilted (or fabric of choice) bag
11 longer handle
12 shorter handle
13 backing to the Velcro or metal/steel sticker to be peeled off and disposed of
14 Velcro or metal/steel sticker to be attached to car door
Velcro or metal/steel patch
16 car door
17 reminder bag carrier
18 Velcro or metal/steel placement patches

### Operation

In the operation, a quilted (or fabric of choice) zipper bag 1 with Velcro base (FIGS. 7 and 8) is detached from the car door 16. It is opened to reveal four synthetic container bags 5. Each of these container bags contains a larger shopping bag 8. This will provide a shopper, in five simple steps, immediate access to four large shopping bags 8.

(1) The quilted (or fabric of choice) zipper bag 1 is attached by means of its Velcro or magnet patch 10 to the Velcro or metal/steel patch 15 on the car door 16.
(2) The bag is detached from the car door's Velcro or metal/steel patch 15 and its zipper 2 is opened to reveal four small synthetic container bags 5.
(3) The zippered reminder bag 17 may be taken by the user into a store.
(4) One of four synthetic container bags (FIG. 4) is removed from the now open quilted (or fabric of choice) zipper bag 1.
(5) The container bag (FIG. 5) is opened. It reveals the larger synthetic shopping bag 8

(FIG. 6) The larger synthetic shopping bag is removed from the container bag and is now ready for use.

As a reminder, the reminder bag carrier may also be used by artists who may carry such necessities as brushes, pencils, tubes of paint and small pads of paper; by journalists who might carry hand-held recording devices, books and pens and by musicians who might carry portable audio and video recording devices. The reminder bags carrier may also be used to carrying wallets, flashlights, spare keys, cell phones, medical supplies and any other item that the consumer may need.

1. A reminder bag carrier comprising:
an outer bag comprising a zippered opening on a face of the bag, and a fastener patch comprising, hook and loop fasteners;
at least one small container bag configured to fit inside the outer bag;
a shopping bag attached to the small container bag, the shopping bag configured to be compressible so as to fit into the small container bag; and
a complementary fastening patch comprising complemented loop fasteners to fasten with the hook and loop fasteners on the fastener patch, wherein the complementary fastening patch is attachable to a door of a vehicle,
wherein the outer bag is configured to be easily taken into a store so that a user can use the shopping bag instead of having to purchase store shopping bags.

2. (canceled)

3. The reminder bag carrier of claim 1, further comprising:
a handle separable into a first pan having a first fixed length and a second part having a second fixed length, each part having a first end and a second end, wherein the first ends of the first and second parts of the handle are attached to the outer bag, and the second ends of the first and second parts of fee handle comprise complementary hook and loop fasteners, wherein the first fixed length and the second fixed length are each shorter than a combined depth and width of the outer bag.

4. The reminder bag carrier of claim 1, further comprising:
a pull cord configured to close the container bag about the shopping bag when the shopping bag is compressed into the container bag.

5. The reminder bag carrier of claim 3, further comprising:
a pull cord configured to close the container bag about the shopping bag when the shopping bag is compressed into the container bag.

6. The reminder bag carrier of claim 1, wherein the outer bag is approximately 5 inches in width by 3 inches in depth by 2.5 inches in height so as to not inconvenience a driver of a ear by virtue of its size.

7. The reminder bag carrier of claim 4, wherein the outer bag is approximately 5 inches in width by 3 inches in depth by 2.5 inches in height so as to not inconvenience a driver of a car by virtue of its size.

8. The reminder bag carrier of claim 5, wherein the outer bag is approximately 5 inches in width by 3 inches in depth by 2.3 inches in height so as to not inconvenience a driver of a car by virtue of its size.

9. A reminder bag carrier comprising:
an enter bag comprising a zippered opening on a face of the bag, and a fastener parch opposite the zippered opening, the fastener patch comprising a magnet;
at least one small container bag configured to fit inside the outer bag;
a shopping bag attached to the small container bag, the shopping bag configured to be compressible so as to fit into the small container bag;
wherein the outer bag is configured to be easily taken into a store so that a user can use the shopping bag instead of having to purchase store shopping bags.

10. The reminder bag carrier of claim 9, further comprising:
a handle separable into a first part having a first fixed length and a second part having a second fixed length, each part having a first end and a second end, wherein the first ends of the first and second parts of the handle are attached to the outer bag, and the second ends of the first and second parts of the handle comprise complementary hook and loop fasteners, wherein the first fixed length and the second fixed length are each shorter than a combined depth and width of the outer bag.

11. The reminder bag carrier of claim 9, further comprising:
a pull cord configured to close the container bag about the shopping bag when the shopping bag is compressed into the container bag.

12. The reminder bag carrier of claim 10, further comprising:
a pull cord configured to close the container bag about the shopping bag when the shopping bag is compressed into the container bag.

13. The reminder bag carrier of claim 9, wherein the outer bag is approximately 5 Inches in width by 3 inches in depth by 2.5 inches in height so as to not inconvenience a driver of a car by virtue of its size.

14. The reminder bag carrier of claim 10, wherein the outer bag is approximately 5 inches in width by 3 inches in depth by 2.5 inches in height so as to not inconvenience a driver of a car by virtue of its size.

15. The reminder bag carrier of claim 11, wherein the outer bag is approximately 3 inches in width by 3 inches in depth by 2.5 inches in height so as to not inconvenience a driver of a car by virtue of its size.

16. The reminder bag carrier of claim 12, wherein the outer bag is approximately 5 inches in width by 3 inches in depth by 2.5 inches in height so as to not inconvenience a driver of a car by virtue of its size.

17. A reminder bag carrier comprising:
an outer bag comprising a zippered opening on a face of the bag, and a fastener patch opposite the zippered opening;
at least one small container bag configured to fit inside the outer bag;
a shopping bag attached to the small container bag, the shopping bag configured to be compressible so as to fit into the small container bag;
wherein the outer bag is configured to be easily taken into a store so that a user can use the shopping bag instead of having to purchase store shopping bags;
a handle separable into a first part having a first fixed length and a second part having a second fitted length, each part having a first end and a second end, wherein the first ends of the first and second parts of the handle are attached to fee outer bag, and the second ends of the first and second parts of the handle comprise complementary hook and loop fasteners configured to be attached to a person's clothing or clothing accessories, wherein the first fixed length and the second fixed length are each shorter than a combined measurement of a depth and width of the outer bag.

18. The reminder bag carrier of claim 17, further comprising:
a pull cord configured to close the container bag about the shopping bag when the shopping bag is compressed into the container bag.

19. The reminder bag carrier of claim 18, wherein the outer bag is approximately 5 inches in width by 3 inches in depth by 2.5 inches in height so as to not inconvenience a driver of a car by virtue of its size.

20. The reminder bag carrier of claim 1, wherein the fastener patch is located on a bottom surface of the outer bag opposite the zippered opening, wherein a surface area of the fastener patch is at least 50 percent of a surface area of the bottom surface.

21. The reminder bag carrier of claim 9, wherein the fastener patch is located on a bottom surface of the outer bag opposite the zippered opening, wherein a surface area of the fastener patch is at least 50 percent of a surface area of the bottom surface.
